(19) United States
(12) Patent Application Publication
(10) Pub. No.: US 2025/0389199 A1
(43) Pub. Date: Dec. 25, 2025

(54) Tie Shaft Leakage Control

(71) Applicant: RTX Corporation, Farmington, CT (US)

(72) Inventors: Alexander Vasili Rozendaal, Berlin, CT (US); Xuejun Liu, Avon, CT (US); Daniel Lauffer Carminati, Berlin, CT (US); Matthew Paul Wilcox, Madison, CT (US)

(73) Assignee: RTX Corporation, Farmington, CT (US)

(21) Appl. No.: 18/749,491

(22) Filed: Jun. 20, 2024

(51) Int. Cl. F01D 11/00

(52) U.S. Cl. CPC F01D 11/003; F01D 11/005; F05D 2220/32; F05D 2240/55

(57) ABSTRACT

A turbine engine rotor has a central longitudinal axis and included: a central shaft having an outer diameter seal groove and a plurality of holes forward of the seal groove; a disk stack having a plurality of disks encircling the shaft; and a split ring seal captured in the groove and engaging an inner diameter surface of one of the disks. The plurality of holes include: a first group; and a second group spaced forward of the first group and circumferentially alternating therewith.

### BACKGROUND

The disclosure relates to gas turbine engines. More particularly, the disclosure relates to disk-to-shaft sealing in center-tie rotors.

Gas turbine engines (used in propulsion and power applications and broadly inclusive of turbojets, turboprops, turbofans, turboshafts, industrial gas turbines, and the like) often feature center-tie rotors wherein a shaft passes centrally through a rotor disk stack with engagement between the shaft and stack such that the shaft is held in tension and the stack is held in compression.

Operational stresses (including thermal stresses and load stresses) may cause excursions between disks and shaft. Accordingly, there often are seals between disk and shaft. In an example high pressure compressor (HPC) rotor in a multi-spool engine an example sealing system involves a piston seal ring (PSR) held in an outer diameter groove in the shaft and interfacing with an inner diameter (ID) surface of a disk bore. The seal may isolate an inter-disk space aft thereof that's used to pass air radially inward to then pass aft a to the turbine section for turbine cooling. Additionally, a diverted airflow may pass radially through holes in the shaft from forward of the seal to pass forward and/or aft within the shaft to provide bearing cooling. Nevertheless, leakage through the joint of the PSR remains a problem.

### SUMMARY

One aspect of the disclosure involves a turbine engine rotor having a central longitudinal axis and comprising: a central shaft having an outer diameter seal groove and a plurality of holes forward of the seal groove; a disk stack having a plurality of disks encircling the shaft; and a split ring seal captured in the groove and engaging an inner diameter surface of one of the disks. The plurality of holes comprises: a first group; and a second group spaced forward of the first group and circumferentially alternating therewith.

In a further example of any of the foregoing, additionally and/or alternatively: the first group of holes is within an axial span of a bore of said one of the disks; and the second group of holes is not even partially within said axial span and is only partially within an axial span of a bore of a disk immediately forward of said one of the disks.

In a further example of any of the foregoing, additionally and/or alternatively: the first group of holes is the only holes through the shaft within the axial span of said bore of said one of the disks; and the second group of holes is the only holes through the shaft within the axial span of said bore of said immediately forward disk.

In a further example of any of the foregoing, additionally and/or alternatively: here are the same number of holes in the first group and second group; and the holes of the first group and second group are all of the same diameter.

In a further example of any of the foregoing, additionally and/or alternatively, centers of the second group are forward of centers of the first group by 200% to 400% of a diameter of the holes of the first group.

In a further example of any of the foregoing, additionally and/or alternatively, a center of the split of the split ring seal is within 10° of a center of one of the holes of the second group.

In a further example of any of the foregoing, additionally and/or alternatively, a center of a forward opening of the split of the split ring seal is within 10° of a center of one of the holes of the second group.

In a further example of any of the foregoing, additionally and/or alternatively, a forward opening of the split of the split ring seal is fully angularly overlapped by one of the holes of the second group.

In a further example of any of the foregoing, additionally and/or alternatively, a forward opening of the split of the split ring seal angularly overlaps a center of one of the holes of the second group.

In a further example of any of the foregoing, additionally and/or alternatively, a center of an aft opening of the split seal ring is angularly offset from a center of a forward opening of the split of the split ring seal in a direction of shaft rotation.

In a further example of any of the foregoing, additionally and/or alternatively, there are three to six holes in each of the first group and second group.

In a further example of any of the foregoing, additionally and/or alternatively, the seal split is between an adjacent pair of holes of a rearward group of the holes so as to not circumferentially overlap therewith.

In a further example of any of the foregoing, additionally and/or alternatively, the first group and second group are drilled circular holes.

A further aspect of the disclosure involves a gas turbine engine including the turbine engine rotor wherein the rotor is a high pressure compressor rotor. The engine further comprises: a high pressure turbine rotor co-spooled with the high pressure compressor rotor on a high spool; a low spool comprising a low pressure compressor rotor and a low pressure compressor rotor; a combustor; a gaspath sequentially through the low pressure compressor, high pressure compressor, combustor, high pressure turbine, and low pressure turbine.

A further aspect of the disclosure involves a method for using the turbine engine, the method comprising: compressing air in the low pressure compressor and high pressure compressor; combusting fuel with compressed air in the combustor to produce combustion gas; expanding the combustion gas in the high pressure turbine and low pressure turbine; a first flow of compressed air passing aft along an outer diameter surface of the shaft to pass radially inward through the plurality of holes; and a leakage flow of compressed air passing forward through the split ring seal to mix with the first flow.

A further aspect of the disclosure involves a turbine engine rotor comprising: a central shaft having an outer diameter seal groove and a plurality of holes forward of the seal groove; a disk stack having a plurality of disks encircling the shaft and held in compression by tension in the shaft; a split ring seal captured in the groove and engaging an inner diameter surface of one of the disks; and means forward of the groove reducing thermal asymmetry in the shaft aft of the groove caused by aft-to-to fore leakage through the seal split.

In a further example of any of the foregoing, additionally and/or alternatively, the means comprises a fore-to-aft stagger in the plurality of holes.

In a further example of any of the foregoing, additionally and/or alternatively, the fore-to-aft stagger in the plurality of holes is of one group relative to another group.

In a further example of any of the foregoing, additionally and/or alternatively, the seal split is between an adjacent pair of holes of a rearward group of the holes so as to not circumferentially overlap therewith.

In a further example of any of the foregoing, additionally and/or alternatively, each of the one group and the another group has exactly four holes.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a cutaway unwrapped radial inward view of a shaft having a piston seal ring in a groove.

FIG. 2 is a cutaway unwrapped radial inward view of a shaft.

FIG. 3 is a schematic sectional view of a shaft and disk interaction taken along line 4-4 of FIG. 1.

FIG. 4 is a schematic sectional view of a shaft and disk interaction taken along line 4-4 of FIG. 1.

Like reference numbers and designations in the various drawings indicate like elements.

### DETAILED DESCRIPTION

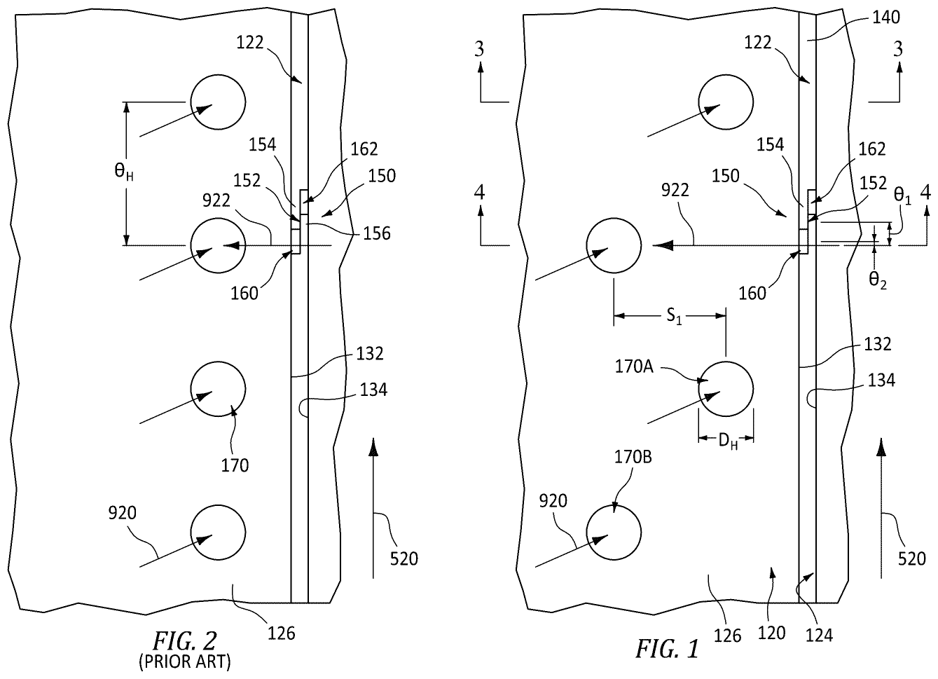

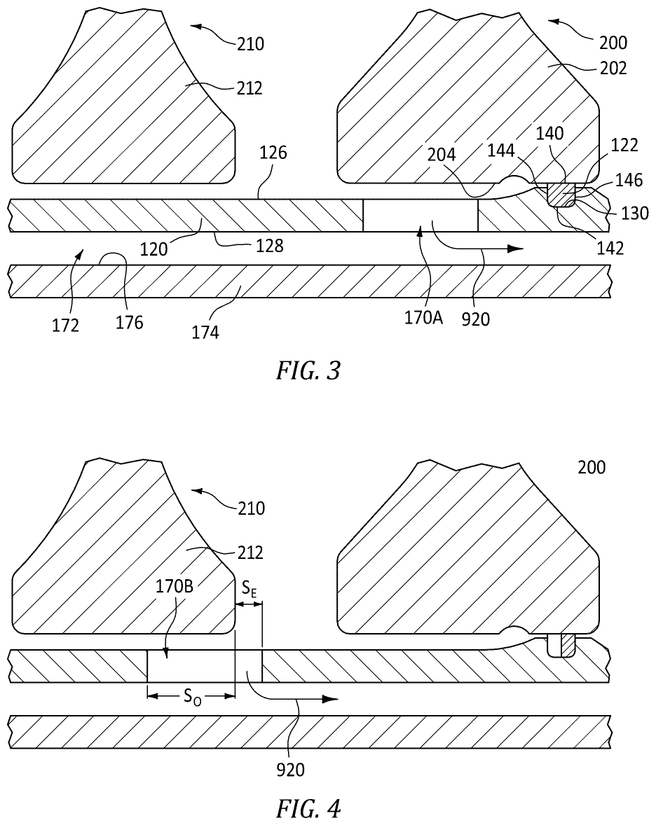

FIG. 1 shows a high speed shaft 120 (tie shaft (TS)) of a two-spool engine and having a piston seal ring (PSR) 122 captured in a shaft groove 124. The shaft 120 has an outer diameter (OD) surface 126 and an inner diameter (ID) surface 128 (FIG. 3). The groove has a base surface 130 (FIG. 3) and respective fore and aft surfaces 132 and 134. The PSR 122 has an OD surface 140, an ID surface 142, a fore surface 144, and an aft surface 146. The example PSR is a split ring with an example shiplap joint 150 (FIG. 2). The joint has a center of overlap 152 of respective fore and aft terminal sections 154 and 156 at respective circumferential ends of the seal. The shiplap joint has respective fore and aft gaps 160 and 162. In the FIG. 2 baseline, a circumferential array of through-holes 170 extend between the OD surface 126 and ID surface 128 just forward of the groove 124. Secondary airflows 920 flow aft along the OD of the shaft and radially inwardly through the holes 170 to, in turn, pass to an annular space (annulus) 172 between the ID surface 128 and the OD surface 176 of a low speed shaft 174. Flow 920 (plus mixed in leakage flow 922 which is biased to the adjacent hole 170B) passes (FIG. 3) aft through the annulus 172 for purposes such as bearing compartment buffering.

FIG. 2 shows a leakage flow 922 passing through the shiplap joint and mixing with the flow 920 through one of the holes 170. The relatively hot flow 922 causes circumferential thermal dis-uniformities/asymmetries in the high speed shaft, thereby locally bowing the shaft slightly.

As is discussed further below, modeling has indicated an advantageous reduction in flow asymmetry when the shaft apertures/holes forward of the PSR are not all at the same longitudinal position. FIG. 1 shows a situation where, relative to a baseline (FIG. 2), every other hole 170B is shifted forward by a longitudinal on-center spacing S₁ (relative to the half of holes 170 Preserved as 170A) and the PSR split is generally circumferentially aligned with one of those forwardly-staggered holes 170B. In the particular example, all three of (a) the baseline holes 170, (b) the first group of holes (first holes) 170A representing the half of the baseline holes that remain in position, and (c) the second group of holes (second holes) 170B shifted forward from the baseline, have the same diameter D_{H}. An example hole count for each of the two groups is four, more broadly, three to eight or three to six.

Example S₁ is 200% to 400% of said D_{H}. In yet other situations wherein one or both groups of holes are resized, the 200% to 400% range may be applied to the diameter of either of the groups.

The example baseline holes and first group have an axial span falling entirely within the axial span of the bore of the particular disk that engages the seal so as to be fully overlapped by the bore. More broadly, they may fall at least partially within the axial span so as to partially overlap (e.g. at least 90%). In the example, the span of the second holes is shifted axially forward to have no overlap with said bore. Instead, there is a partial overlap with the bore of the next forward disk. An example amount of overlap S_{O} (diameter D_{H} minus exposure S_{E}) with the bore of the next forward disk is 30% to 100% of the hole diameter (which also forms an axial length), more particularly, 30% to 80%.

Angularly, the split is arranged approximately registered with one of the second holes. One reference point for the split center is the center of overlap. Another is the center of the forward opening 160 of the split (which is angularly shifted relative to the center of the aft opening 162). In the illustrated example, the forward opening is spaced in the opposite direction from the split center relative to the direction of shaft rotation. FIG. 1 shows an angle θ₁ between the center 152 of the split and the circumferential position of the center of the adjacent hole 170B. FIG. 1 also shows an angle θ₂ between the center of the forward opening/gap 160 and the circumferential position of the center of said hole 170B. Example θ₁ is −10° to 10°. Example θ₂ is −10° to 10°. It may be such that the forward gap 160 angular span fully overlaps the angular span of the adjacent hole 170B. More particularly. the angular position of the center of such hole 170 B may be within the angular span of the forward gap 160.

Although one has reason to assume that a yet more uniform situation might be achieved by only staggering one hole forward, this may present mechanical dis-uniformities (e.g., imbalance) that overwhelm the flow benefits. We believe the stagger enables more efficient mixing of the hot leakage flow jet 922 with the native bore flow 920 before entering through the holes. The proposed stagger allows the hot leakage path to cool slightly before entering through the hole 170B. Numerical analysis demonstrated slightly better mixing between the hot leakage flow 922 and upstream bore flow 920, which resulted in less overall thermal asymmetry.

In general, this benefit may be obtained by installing the PSR in a predetermined orientation of its split relative to the staggered holes with no other measures taken for keying/clocking. For example, in initial assembly of the PSR to the groove, the PSR may be held in place. This may maintain angular registry of the split relative to the associated second hole during assembly of disks to the shaft. When the engine is first spun up, centrifugal action may radially expand the PSR and circumferentially expand the split whereafter friction may maintain the PSR split registry with the associated hole. Even small amounts of in-use friction may tend to resist rotational movement.

However, if there is a risk of circumferential drift of the PSR over time bringing it out of alignment with the forwardly staggered hole, a clocking or keying feature (not shown) may be added to angularly retain the PSR relative to the shaft.

Component materials and manufacture techniques and assembly techniques may be otherwise conventional.

One or more embodiments have been described. Nevertheless, it will be understood that various modifications may be made. For example, when applied to an existing baseline configuration, details of such baseline may influence details of particular implementations. Accordingly, other embodiments are within the scope of the following claims.

1. A turbine engine rotor having a central longitudinal axis and comprising:
a central shaft having an outer diameter seal groove and a plurality of holes forward of the seal groove;
a disk stack having a plurality of disks encircling the shaft; and
a split ring seal captured in the groove and engaging an inner diameter surface of one of the disks,
wherein the plurality of holes comprises:
a first group; and
a second group spaced forward of the first group and circumferentially alternating therewith.

2. The turbine engine rotor of claim 1 wherein:
the first group of holes is within an axial span of a bore of said one of the disks; and
the second group of holes is not even partially within said axial span and is only partially within an axial span of a bore of a disk immediately forward of said one of the disks.

3. The turbine engine rotor of claim 2 wherein:
the first group of holes is the only holes through the shaft within the axial span of said bore of said one of the disks; and
the second group of holes is the only holes through the shaft within the axial span of said bore of said immediately forward disk.

4. The turbine engine rotor of claim 1 wherein:
there are the same number of holes in the first group and second group; and
the holes of the first group and second group are all of the same diameter.

5. The turbine engine rotor of claim 1 wherein:
centers of the second group are forward of centers of the first group by 200% to 400% of a diameter of the holes of the first group.

6. The turbine engine rotor of claim 1 wherein:
a center of the split of the split ring seal is within 10.0° of a center of one of the holes of the second group.

7. The turbine engine rotor of claim 1 wherein:
a center of a forward opening of the split of the split ring seal is within 10.0° of a center of one of the holes of the second group.

8. The turbine engine rotor of claim 1 wherein:
a forward opening of the split of the split ring seal is fully angularly overlapped by one of the holes of the second group.

9. The turbine engine rotor of claim 1 wherein:
a forward opening of the split of the split ring seal angularly overlaps a center of one of the holes of the second group.

10. The turbine engine rotor of claim 1 wherein:
a center of an aft opening of the split seal ring is angularly offset from a center of a forward opening of the split of the split ring seal in a direction of shaft rotation.

11. The turbine engine rotor of claim 1 wherein:
there are three to six holes in each of the first group and second group.

12. The turbine engine rotor of claim 1 wherein:
the seal split is between an adjacent pair of holes of a rearward group of the holes so as to not circumferentially overlap therewith.

13. The turbine engine rotor of claim 1 wherein:
the first group and second group are drilled circular holes.

14. A gas turbine engine including the turbine engine rotor of claim 1 wherein the rotor is a high pressure compressor rotor and further comprising:
a high pressure turbine rotor co-spooled with the high pressure compressor rotor on a high spool;
a low spool comprising a low pressure compressor rotor and a low pressure turbine rotor;
a combustor; and
a gaspath sequentially through the low pressure compressor, high pressure compressor, combustor, high pressure turbine, and low pressure turbine.

15. A method for using the turbine engine of claim 14, the method comprising:
compressing air in the low pressure compressor and high pressure compressor;
combusting fuel with compressed air in the combustor to produce combustion gas;
expanding the combustion gas in the high pressure turbine and low pressure turbine;
a first flow of compressed air passing aft along an outer diameter surface of the shaft to pass radially inward through both the first group and the second group of the plurality of holes; and
a leakage flow of compressed air passing forward through the split ring seal to mix with the first flow.

16. A turbine engine rotor comprising:
a central shaft having an outer diameter seal groove and a plurality of holes forward of the seal groove;
a disk stack having a plurality of disks encircling the shaft and held in compression by tension in the shaft; and
a split ring seal captured in the groove and engaging an inner diameter surface of one of the disks,
and further comprising:
means forward of the groove reducing thermal asymmetry in the shaft aft of the groove caused by aft-to-fore leakage through the seal split.

17. The turbine engine rotor of claim 16 wherein the means comprises:
a fore-to-aft stagger in the plurality of holes.

18. The turbine engine rotor of claim 17 wherein the means comprises:
the fore-to-aft stagger in the plurality of holes is of one group relative to another group.

19. The turbine engine rotor of claim 18 wherein:
the seal split is between an adjacent pair of holes of a rearward group of the holes so as to not circumferentially overlap therewith.

20. The turbine engine rotor of claim 18 wherein:
each of the one group and the another group has exactly four holes.
